(19) United States
(12) Patent Application Publication
(10) Pub. No.: US 2021/0028471 A1
(43) Pub. Date: Jan. 28, 2021

(54) METHOD FOR REGULATING THE HUMIDITY OF A MEMBRANE OF A FUEL CELL

(71) Applicant: Robert Bosch GmbH, Stuttgart (DE)

(72) Inventors: Meik VOSS, Untergruppenbach (DE); Simon WEISSENMAYER, Flein (DE)

(21) Appl. No.: 16/639,852

(22) PCT Filed: Aug. 7, 2018
(86) PCT No.: PCT/EP2018/071372

§ 371 Date: Oct. 12, 2020

(30) Foreign Application Priority Data
Aug. 17, 2017 (DE) 10 2017 214 312.6

(51) Int. Cl. H01M 8/04119; H01M 8/04223; H01M 8/18

(52) U.S. Cl. CPC H01M 8/04141; H01M 8/04164; H01M 8/186; H01M 8/04223; H01M 8/04179

(57) ABSTRACT

The invention relates to a method for regulating the humidity of a membrane (12) of a fuel cell, comprising the steps of compressing a cathode gas (2) by means of a compressor (22) and humidifying a cathode gas (2) by supplying water to the cathode gas (2) by means of a supply device, the supply device comprising an injection valve (26) by means of which the water is supplied to the already compressed cathode gas (2) on demand.

### BACKGROUND OF THE INVENTION

The present invention starts from a method or system for regulating the humidity of a membrane of a fuel cell.

It is known from the prior art to actively humidify the membrane arranged between the anode and the cathode of a fuel cell. In PEM fuel cells, the product water produced during the reaction at the cathode of the fuel cell is used for humidifying the membrane. The water that is produced is reused by being separated from the exhaust gas by means of a gas/gas exchanger and then supplied to the fresh air.

### SUMMARY OF THE INVENTION

The invention provides a method wherein the supply device has an injection valve via which water is supplied to the already compressed cathode gas according to requirements, and also a system wherein the supply device has an injection device for supplying water to the cathode gas, and wherein the injection valve is arranged between the compressor and the cathode of the fuel cell. Features and details that are described in connection with the method according the invention naturally also apply in connection with the system according to the invention and vice versa so that, with regard to the disclosure of the individual aspects of the invention, reference always is made or can be made reciprocally.

The method of the invention serves in particular for regulating the humidity of a membrane of a fuel cell, in particular of a PEM membrane of a PEM fuel cell. The advantage of the method is to be seen especially in that the power loss that must be applied for compression of the fresh air supplied on the cathode side can be greatly reduced. In methods known hitherto, the need for compression results predominantly from the heating of the fresh air during the humidification of the air by means of a gas/gas exchanger as is usually carried out. In the mentioned humidification operation, the comparatively high temperature of the humid exhaust air used for humidifying the fresh air is a particular problem. Heating of the exhaust air is thereby attributable in particular to the warm product water which is absorbed by the exhaust air. In the humidification process which takes place in the gas/gas exchanger, the heat of the exhaust air is transferred to the fresh air that is to be humidified. The elevated temperature of the fresh air results in a lower density and thus a smaller amount of oxygen per air volume of the fresh air, which ultimately leads to inefficient operation of a fuel cell. Although inefficient operation in such a case as already explained can be remedied by compression of the fresh air carried out before or after the humidification process, such a compression process requires a high outlay in terms of energy, which can be saved by the method according to the invention. A further advantage of the present method further arises in that a gas/gas exchanger for humidifying the fresh air is deliberately not used according to the invention, with the result not only that space and weight can be saved, but also that the further disadvantages of a gas/gas exchanger, such as in particular the great dependence on external ambient conditions, can be reduced or eliminated.

In the method according to the invention for regulating the humidity of a membrane of a fuel cell, the cathode gas in the present case is first compressed by means of a compressor, wherein various types of compressor can be used as the compressor, such as, for example, rotary compressors, piston compressors, turbo compressors, ionic compressors, scroll compressors and the like. According to the invention, it is proposed that the cathode gas is first compressed to a pressure of at least more than 1 bar, preferably to a pressure of more than 2.5 bar, in particular to a pressure of more than 5 bar. However, before the cathode gas can be compressed, it must first be supplied to the compressor. In the present case there is used as the cathode gas in particular oxygen-containing air, which advantageously is first drawn in from the environment and pre-filtered before being supplied to the compressor. Filtering the air serves both to protect the fuel cell components, in particular the catalyst material of the fuel cell, and to protect the remaining components of the fuel cell system from harmful particles and gaseous impurities from the air that is drawn in. After the cathode gas has been compressed, the cathode gas is in the present case humidified by supplying water by means of a supply device. Because the process of compressing the cathode gas necessarily takes place according to the invention before the cathode gas is humidified—that is to say when the cathode gas is “dry”—a particularly efficient and energy-saving compression process is ensured. If the compression process were not to take place until after humidification, there would additionally be the risk that a portion of the water absorbed by the cathode gas would condense out again and consequently the cathode gas would no longer contain the desired amount of water. In order to be able to humidify the already compressed cathode gas to the desired extent despite a comparatively lower absorbing capacity, it is proposed according to the invention that the supply device has an injection valve via which the water is supplied to the already compressed cathode gas according to requirements. By means of the injection valve according to the invention there is in the meantime made available a humidification method which not only meets requirements but in particular is significantly more efficient compared to the gas/gas exchanger conventionally used for this purpose. In addition to an injection valve, the supply device can further comprise further elements, for example one or more valves of different types, one or more pumps of different types, different lines or a line system, at least one control unit for controlling the supply of water to a cathode gas, at least one measuring device for determining a water requirement, at least one communication device for communication and the like.

Advantageously, it can be provided within the scope of the invention that the water supplied to the cathode gas according to requirements via the supply device and preferably obtained from the exhaust air of the fuel cell is collected and in particular cooled in a reservoir before being supplied to the supply device. The supply of cooled or cold water is in particular advantageous because the volume of the fresh air does not change, or does not change to an extent that adversely affects the energy conversion, after humidification, so that the cathode gas also has the same density—that is to say accordingly contains the same amount of oxygen per volume—after humidification. This not only prevents inefficient operation of the fuel cell but also ensures an energy supply that is as constant as possible. In order additionally to operate the fuel cell with a largely constant energy even under greatly fluctuating ambient conditions, not only can the reservoir be cooled but its temperature can advantageously be controlled according to requirements, wherein the temperature is controlled in particular in dependence on the ambient conditions and/or on the electrical energy currently being produced or converted. In order additionally to have to use as little energy as possible for cooling the reservoir and in particular not to have to cool against the heat of reaction, it is further proposed that the reservoir is arranged remote from the fuel cell. For supplying the injection valve with the water collected and preferably cooled in the reservoir, at least one pump can then preferably be provided, which pump conveys the water to the injection valve according to requirements. In order to ensure that water is conveyed according to requirements, there can additionally be provided a communication link between the injection valve and the pump, or between the injection valve, the pump and the reservoir, and also a control unit which is able to detect at least the requirement for and the amount of stored water and can thus control metering in accordance with requirements.

It is further conceivable that the water contained in the supply device is removed from the supply device at least partially, preferably completely, before the fuel cell is switched off. Removal of water from the supply device is advantageous in particular against the background of the use of the fuel cell at temperatures around or below 0° C., in order to prevent possible freezing of the water in the supply device. Freezing of water in the supply device could lead to at least parts of the supply device being damaged or even destroyed. In terms of as compact an arrangement as possible, it is additionally proposed that the same pump or the same pumps is/are used for removing the water from the supply device as are already provided for supplying the water obtained from the exhaust air from the reservoir to the injection valve. In a simple form, the pump or pumps can in this case be operated backwards in order to convey the water from the supply device back into the reservoir. Alternatively, separate pumps for conveying the water from the supply device back into the reservoir can correspondingly also be provided. Alternatively or in addition to guiding the water back out of the supply device into the reservoir, it is also possible to provide a heating device comprising band heaters and the like and/or a blow-out device.

Furthermore, it is conceivable, in particular at ambient temperatures in the region of 0° C., that a larger amount of water than necessary is optionally supplied to the membrane, preferably when the reservoir is substantially completely full. Such a supply of excess water at ambient temperatures in the region of 0° C. is expedient in particular in order to protect the reservoir from being damaged or bursting. Alternatively or in addition to such a supply of excess water, the reservoir can also be designed to withstand freezing, for example can be made of a particularly expandable material and/or have a heating device which correspondingly heats the reservoir at least when there is the risk of its bursting, in order to prevent it from bursting. Alternatively, in contrast to the supply of excess water to the membrane at ambient temperatures in the region of 0° C., a supply can also be reduced, in particular stopped, in order to protect the membrane from frost damage. In this case, alternatively or in addition to the reservoir having a design that withstands freezing and/or to the arrangement of a heating device, the reservoir can have a temperature-controlled outlet valve which lets water out of the reservoir at ambient temperatures in the region of 0° C. so that there is no risk of the reservoir bursting even if the water from the reservoir freezes completely.

Advantageously, it can likewise be provided within the scope of the invention that air is evacuated from the supply device at least partially, preferably completely, before the fuel cell is activated. Complete evacuation of air from of the supply device is expedient in particular because the residual air is thereby removed from the supply device. This residual air generally has an at least undefined oxygen content, an at least undefined temperature and an at least undefined water content. Generally, however, the residual air has a lower oxygen content and/or a higher temperature and/or a lower water content than the fresh air, so that evacuation of air from the supply device, in particular complete evacuation of air, is advantageous within the scope of an efficient chemical conversion and a constant energy supply. The injection valve can preferably be used for evacuating air, wherein the injection valve is in particular supplied with water from the reservoir via the pump only when an ability to inject is detected. Only then can the fresh air be humidified with water with the aid of the injection valve.

It can further be provided within the scope of the invention that the humidity of the cathode gas is determined during operation of the fuel cell by means of a hygrometer and the injection of water is regulated on the basis of the currently determined humidity. Such an adaptation of the injection of water to the currently determined humidity is expedient in particular in the case of greatly fluctuating ambient temperatures and permits optimum conversion of chemical energy into electrical energy and also an energy supply that is as constant as possible even under such conditions. For this purpose, the hygrometer is preferably to be arranged between the injection valve and the cathode.

It can further be provided within the scope of the invention that the fresh air is first guided through a gas/gas exchanger and the humidity is thereby increased. In order to supply the fuel cell with fresh air containing the optimum amount of humidity, the humidity that is still lacking can thereafter be supplemented by the injection of water. In this method, the gas/gas exchanger can preferably be made substantially smaller, and a valve parallel to the exchanger can preferably be omitted.

The invention likewise provides a system for regulating the humidity of a membrane of a fuel cell. In the present case, it is provided that the system comprises a compressor for compressing a cathode gas and a supply device for humidifying the cathode gas by supplying water to the cathode gas, wherein the supply device has an injection valve for supplying water to the cathode gas and wherein the injection valve is arranged between the compressor and the cathode of the fuel cell. The system according to the invention thus brings with it the same advantages as have been described in detail in relation to the method according to the invention. As has already been explained in the statements relating to the method according to the invention, the present system is preferably provided for regulating the humidity of a membrane of a PEM fuel cell. Based on the replacement of a gas/gas exchanger for humidifying a cathode gas by an injection valve, it is possible, in addition to the advantages of space and weight savings, in particular to use less energy for compressing a cathode gas. Because the compressor is arranged according to the invention between the injection valve and the cathode, the process of compressing the cathode gas also necessarily takes place according to the invention before the cathode gas is humidified—that is to say when the cathode gas is “dry”, so that not only a more efficient but also a more energy-saving compression process is ensured. In addition, there is no risk that the already humidified cathode gas will lose humidity during the compression process. Within the scope of the invention, the expression injection valve includes both valves and injectors as well as nozzles and the like. The injection valve can further be addressable in different ways, or can be controlled in different ways. The injection valve in the present case can be a magnetically, preferably pneumatically, in particular electronically, controlled injection valve. Preferably, the injection valve has a nozzle, in particular an atomizing nozzle, for the efficient humidification of the cathode gas. The nozzle itself can be formed in different ways and can follow different atomization concepts. Advantageously, it is proposed that that injection valve has a one-component nozzle, in particular a two-component nozzle, for atomizing the supplied water. One-component nozzles are advantageous because they use only their own energy for atomizing the supplied liquid and the supply of additional compressed air is generally not required. By means of two-component nozzles, on the other hand, a significantly more efficient humidification is generally possible because two-component nozzles use a second medium, such as compressed air, different gases or the like as suppliers of energy for the atomization, which achieves extremely high speeds even at relatively low pressure differences and thus effects extremely fine atomization of the liquid.

It is further proposed within the scope of this invention that the system has a hygrometer for detecting a current humidity of the cathode gas, wherein the hygrometer is arranged between the injection valve and the cathode, in particular is electrically connected to the supply device and/or the injection valve. Such an arrangement of a hygrometer in particular allows the injection of water to be adapted to the currently determined humidity. This is expedient in particular in the case of greatly fluctuating ambient temperatures and, even under such conditions, allows optimum conversion of chemical energy into electrical energy as well as an energy supply that is as constant as possible. For an adaptation that is optimized in terms of time, the hygrometer can preferably comprise a controller for detecting the current humidity, in particular a P and/or a PI and/or a PD and/or a PID controller. For controlling the system according to the invention, in particular for controlling the humidification of a cathode gas in accordance with requirements, the individual system components are preferably connected to one another via control or communication links. The control or communication links can be at least partially wireless and/or at least partially wired. Advantageously, the control and/or communication links can be connected to one another via a BUS system, in particular a CAN BUS system. It is further advantageous if the present system comprises a superordinate control device for control. The superordinate control device can either be arranged separately or can be integrated into one of the devices of the system according to the invention, preferably into the injection valve. Alternatively, the superordinate control device can also be arranged remote from the system according to the invention for regulating the humidity of a membrane and can be connected to the individual components in a wired manner, preferably wirelessly, for communication and control.

The system according to the invention can further have a reservoir for storing and/or cooling water obtained from the exhaust air of the fuel cell. Storing and cooling the water obtained from the exhaust air is advantageous in particular because the exhaust air from the fuel cell is heated considerably as a result of the heat of reaction and thus, if used directly for humidification, would have the disadvantage that the cathode gas to be humidified would likewise be heated considerably during the humidification process. As has already been explained, this is disadvantageous in particular from the point of view of energy. For this reason, it is especially appropriate to store and cool the water obtained from the exhaust air of the fuel cell before that water can be used for humidifying the fresh air. In order additionally to operate the fuel cell with a largely constant energy even under greatly fluctuating ambient conditions, the reservoir can have not only a pure cooling device but in particular a temperature-control device which is capable of controlling the temperature of the water in the reservoir according to requirements, in particular in dependence on the ambient conditions and/or the electrical energy currently being produced or converted. For supplying the injection valve with the water collected and preferably cooled in the reservoir, there can then preferably be provided at least one pump which conveys the water to the injection valve according to requirements. In order to ensure conveying according to requirements, there can additionally be provided a communication link between the injection valve and the pump, or between the injection valve, the pump and the reservoir, and also a control unit which can detect at least the requirement for and the amount of stored water and thus can meter the water according to requirements.

In order to be able to operate the present system for regulating the humidity safely even at ambient temperatures around 0° C., it can likewise be provided that the reservoir and/or the lines that connect the reservoir to the injection valve have a heating device for heating the water. This is advantageous in particular for protecting the lines, valves and the reservoir from frost damage. In order to prevent unnecessary energy consumption of the heating devices, it can additionally be provided that the corresponding devices are activatable only at ambient temperatures of around 0° C.

Further advantages, features and details of the invention will become apparent from the following description, in which exemplary embodiments of the invention are described in detail with reference to the drawings. The features mentioned in the claims and in the description can thereby each be fundamental to the invention on their own or in any desired combination.

### BRIEF DESCRIPTION OF THE DRAWINGS

In the figures:

FIG. 1 shows a schematic representation of a system for regulating the humidity of a membrane according to the prior art;

FIG. 2 shows a schematic representation of a system according to the invention for regulating the humidity of a membrane.

In the figures, identical reference numerals are used for the same technical features.

### DETAILED DESCRIPTION

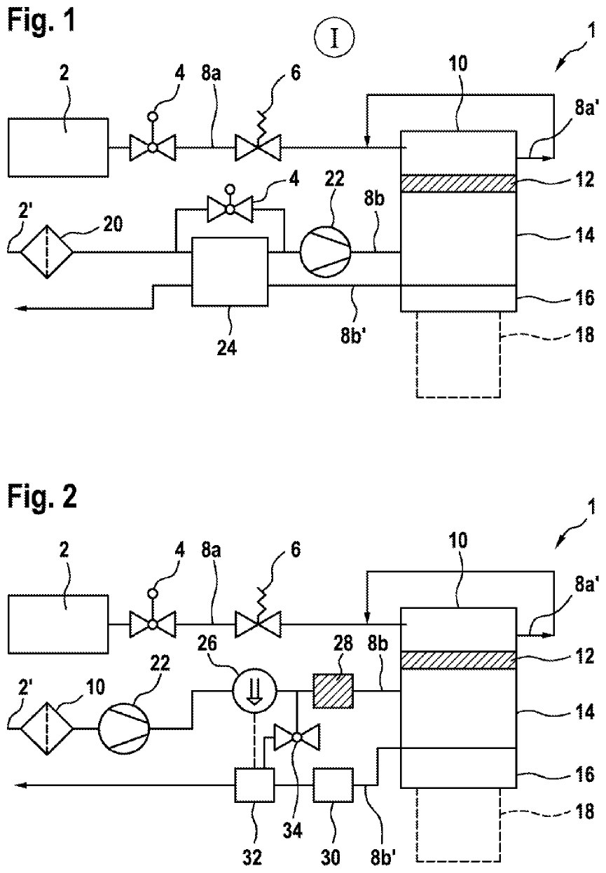

FIG. 1 shows a schematic representation of a system 1 for regulating the humidity of a membrane 12 according to the prior art. The system 1 comprises a fuel cell with an anode 10 and a cathode 14 which are separated from one another by the membrane 12. For cooling the fuel cell, a cooling unit 16 comprising a cooling circuit 18 is arranged on the side of the cathode 14 of the fuel cell. Both the anode 10 and the cathode 14 are electrically connected to the membrane 12. During operation, the anode gas 2, which in the present case is hydrogen, flows around the anode 10 of the fuel cell. For this purpose, the hydrogen 2 is conducted into the anode supply line 8a by opening the shut-off valve 4. By regulated opening of the metering valve 6, the anode gas 2 flows through the second part of the anode supply line 8a arranged downstream of the metering valve 6, before the anode gas 2 reaches the anode 10. The cathode gas 2′, in the present case oxygen-containing fresh air, is introduced on the opposite side to the anode gas 2. The air 2′ is drawn in and first filtered in the air filter 20. Filtering the air serves both to protect the fuel cell components, in particular the catalyst material of the fuel cell, and to protect the remaining components of the fuel cell system from harmful particles and gaseous impurities from the air that is drawn in. After filtration, the cathode gas 2′ is humidified with the aid of the gas/gas exchanger 24 by guiding the fresh air 2′ past the exhaust air which likewise passes through the gas/gas exchanger 24 and is laden with product water. For air evacuation purposes, a bypass provided with a shut-off valve 4 is arranged at the gas/gas exchanger 24. The exhaust air leaves the fuel cell on the cathode side 14 via the cathode discharge line 8b′ and passes through the gas/gas exchanger 24. In this manner, the water formed on the side of the cathode 14 in the reaction is reused for humidifying the fresh air 2′. After humidification of the fresh air 2′ within the gas/gas exchanger 24, the air 2′ is compressed by means of the compressor 22 before the humidified and compressed cathode gas 2′ is supplied to the cathode 14 via the cathode supply line 8b and the chemical reaction between the anode and cathode gas 2, 2′ takes place at the membrane. The anode gas 2 not consumed in the reaction in the meantime leaves the fuel cell via the anode discharge line 8a′ and is supplied to the cycle again via the anode supply line 8a′. A problem with this type of design is in particular the fact that a very large amount of energy must be used for compressing the cathode gas 2′ before it is supplied to the fuel cell. The high compression energy results from the heating of the cathode gas 2′ during humidification in the gas/gas exchanger 24. Heating of the cathode gas 2′ during humidification in the gas/gas exchanger 24 is in turn attributable to the exhaust air heated by the heat of reaction. In order to be able to introduce a sufficient amount of oxygen per volume despite the heating of the humidified cathode gas 2′ and the resulting lowered density, the cathode gas 2′ must be compressed in a manner that is expensive in terms of energy. Only in that manner is it possible to ensure optimum chemical conversion of the reactants and as constant an energy supply as possible.

FIG. 2 shows a schematic representation of a system 1 according to the invention for regulating the humidity of a membrane 12 in distinction to FIG. 1. In contrast to the system 1 shown in FIG. 1, the system 1 according to the invention does not have a gas/gas exchanger 24 for humidifying the fresh air 2′ introduced on the cathode side of the fuel cell. Instead, an injection valve 26 is used for humidifying the fresh air 2′. By means of the injection valve 26 and the hygrometer 28 it is possible to detect the current humidity of the fresh air 2′ and control the humidification by the injection valve 26 according to the current humidity. The injection valve 26 receives the necessary water via a pump 32, which conveys the water from a reservoir 30 to the injection valve 26. The water obtained from the exhaust air is stored and preferably cooled in the reservoir 30. Between the pump 32 and the cathode gas supply line 8b there is further arranged a shut-off valve 34 which is preferably used for evacuating air from the supply device before the fuel cell is started. For controlling the system according to the invention, the individual system components are connected to one another via communication links, not shown here, preferably via a BUS system, in particular a CAN BUS system. Advantageously, the system 1 comprises a superordinate control device, likewise not shown, for controlling the system 1, in particular for controlling the admission of air, the evacuation of air, and the metering according to requirements. The superordinate control device can either be arranged separately or can be integrated into one of the other devices, preferably into the injection valve 26. Alternatively, the superordinate control device can also be arranged remote from the system 1 for regulating the humidity of a membrane 12 and can be connected to the individual components in a wired manner, preferably wirelessly, for communication and control. By using the injection valve 26 according to the invention instead of a gas/gas exchanger 24, not only can valuable space and weight be saved, but the power loss that must be applied for the compression of the supplied fresh air 2′ can also be greatly reduced because the supplied fresh air 2′ can be humidified by the injection valve 26 very efficiently and without heat transfer, so that the need for excessive compression of the cathode gas 2′ is eliminated. In addition to the use of the injection valve 26 instead of a gas/gas exchanger 24, the compressor 22 is further arranged according to the invention not between the device 26 which serves to humidify the fresh air 2′ and the cathode 14 but upstream of the injection valve 26. Because the process of compressing the cathode gas 2′ necessarily takes place according to the invention before the cathode gas 2′ is humidified that is to say when the cathode gas 2′ is “dry”, a particularly efficient and energy-saving compression process is ensured.

1. A method for regulating the humidity of a membrane (12) of a fuel cell, comprising the steps of:
compressing a cathode gas (2′) by means of a compressor (22), and
thereafter humidifying the cathode gas (2′) by supplying water to the cathode gas (2′) by means of a supply device,
wherein the supply device has an injection valve (26) via which the water is supplied to the already compressed cathode gas (2′) according to requirements.

2. The method as claimed in claim 1, characterized in that the water that is supplied to the cathode gas (2′) via the supply device according to requirements is obtained from exhaust air of the fuel cell.

3. The method as claimed in claim 1, characterized in that the water contained in the supply device is removed from the supply device at least partially before the fuel cell is switched off.

4. The method as claimed in claim 1, characterized in that a larger amount of water than necessary is optionally supplied to the membrane (12).

5. The method as claimed in claim 1, characterized in that the humidity of the cathode gas (2′) is determined during operation of the fuel cell by means of a hygrometer (28), and the injection of water is regulated on the basis of the currently determined humidity.

6. The method as claimed in claim 1, characterized in that the humidity of the cathode gas (2′) is first increased by a gas/gas exchanger (24) and then the amount of water that is still lacking from the fresh air is supplemented from the injection of water.

7. A system (1) for regulating the humidity of a membrane (12) of a fuel cell, comprising:
a compressor (22) for compressing a cathode gas (2′), and
a supply device for humidifying the cathode gas (2′) by supplying water to the cathode gas (2′),
wherein the supply device has an injection device (26) for supplying water to the cathode gas (2′), and
wherein the injection valve (26) is arranged between the compressor (22) and the cathode (14) of the fuel cell.

8. The system (1) as claimed in claim 7, characterized in that the system (1) has a hygrometer (28) for detecting a current humidity of the cathode gas (2), wherein the hygrometer (28) is arranged between the injection valve (26) and the cathode (14).

9. The system (1) as claimed in claim 7, characterized in that the system (1) has a reservoir (30) for storing and/or cooling water obtained from the exhaust air of the fuel cell.

10. The system (1) as claimed in claim 7, characterized in that the reservoir (30) and/or the lines that connect the reservoir (30) to the injection valve (26) have a heating device for heating the water, wherein the heating device is activatable.

11. The system (1) as claimed in claim 7, characterized in that the system (1) has a hygrometer (28) for detecting a current humidity of the cathode gas (2), wherein the hygrometer (28) is arranged between the injection valve (26) and the cathode (14) and is electrically connected to the supply device and/or the injection valve (26).

12. The system (1) as claimed in claim 7, characterized in that the system has a gas/gas exchanger (24).

13. The system (1) as claimed in claim 7, characterized in that the reservoir (30) and/or the lines that connect the reservoir (30) to the injection valve (26) have a heating device for heating the water, wherein the heating device is activatable at ambient temperatures around 0° C.

14. The method as claimed in claim 1, characterized in that the water that is supplied to the cathode gas (2′) via the supply device according to requirements is obtained from exhaust air of the fuel cell, wherein the water is collected in a reservoir (30) before being supplied to the supply device.

15. The method as claimed in claim 1, characterized in that the water that is supplied to the cathode gas (2′) via the supply device according to requirements is obtained from exhaust air of the fuel cell, wherein the water is cooled in a reservoir (30) before being supplied to the supply device.

16. The method as claimed in claim 1, characterized in that the water contained in the supply device is removed from the supply device completely before the fuel cell is switched off.

17. The method as claimed in claim 1, characterized in that air is evacuated from the supply device at least partially before the fuel cell is activated.

18. The method as claimed in claim 1, characterized in that air is evacuated from the supply device completely before the fuel cell is activated.

19. The method as claimed in claim 1, characterized in that a larger amount of water than necessary is optionally supplied to the membrane (12) when the reservoir (30) is substantially completely full.

20. The method as claimed in claim 1, characterized in that a larger amount of water than necessary is optionally supplied to the membrane (12) when the reservoir (30) is substantially completely full, at ambient temperatures in the region of 0° C.
